(19) United States
(12) Patent Application Publication
(10) Pub. No.: US 2009/0090233 A1
(43) Pub. Date: Apr. 9, 2009

(54) Hi-Hat Cymbal Fine Adjuster

(76) Inventor: Brian Romolino, Henderson, NV (US)

Correspondence Address: TRAVIS CHANDLER, PHD, LLC, 1489 WEST WARM SPRINGS ROAD, SUITE 110, HENDERSON, NV, 89014, US

(21) Appl. No.: 11/869,647

(22) Filed: Oct. 9, 2007

(51) Int. Cl. G10D 13/06

(52) U.S. Cl. 84/422.3

(57) ABSTRACT

A high-hat cymbal fine adjustment device is disclosed comprising an assembly of an outer vertical shaft or sleeve with an inner vertical shaft or sleeve to allow fine adjustment of the position of the lower cymbal with respect to the upper cymbal. Each shaft has threads machined into its inner or outer surface respectively so that by rotation of the upper inner shaft with respect to the upper outer sleeve, the distance between cymbals may be set precisely and rapidly, and adjustments made in the course of performance if desired. Incorporation of a locking ring secures the positions of the components so that they do not move due to vibration during performance or use.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention is in the field of percussion instruments in the musical arts, and pertains more specifically to hi-hat cymbal apparatus and methods for operating same.

### BACKGROUND OF THE INVENTION

For many drummers, especially those who perform in rock and roll or jazz groups, their equipment is usually a set of instruments, commonly called a kit. A modern kit includes several sorts of drums on stands, such as snare drums, one or more base drums, various sorts of bells and cymbals, and more. Most kits include a cymbal set normally called a hi-hat. The present invention is principally concerned with such hi-hats.

A hi-hat is a cymbal set having two opposed cymbals oriented substantially vertically with respect to each other and normally spaced apart by a short distance, where the cymbals are mounted on a vertical stand so that they are within reach of the performer. The lower cymbal of the two-cymbal set is typically suspended in a felt-padded flange or clamping device firmly attached to a stationary hollow vertical shaft. This lower cymbal does not normally change position during a performance. The overall height of the lower cymbal may be set by use of an inner sleeve and outer sleeve combination in the lower support shaft, where the inner sleeve is fixed in place with an adjusting device consisting of a set-screw or thumb-screw mounted into a collar at the upper end of the outer sleeve of the hollow shaft.

The upper cymbal of the two-cymbal set of a hi-hat is typically suspended in a felt-padded clamping device attached to a rod passing up through the stationary hollow vertical shaft and guided in linear bearing guides within the hollow shaft. The clamping device for the upper cymbal in the prior art contains a provision for adjustment, usually a set screw such as a thumb screw that runs through a collar mounted on the rod carrying the upper cymbal assembly. The rod carrying the upper cymbal is operable by a spring-biased foot pedal.

A drummer in some instances may strike the upper cymbal with a drum stick with the hi-hat in the “open” position, in which case the sound is that of a felt-suspended cymbal. The drummer may create another sound by closing, that is, by bringing the cymbals together by depressing the foot-pedal. The hi-hat is normally open, where the upper cymbal is elevated a small distance above the lower cymbal. The open position may be accomplished by means of a spring between the walls of the hollow shaft and the rod carrying the upper cymbal, or alternatively by spring devices incorporated into the foot pedal assembly. The hi-hat is closed by depressing the foot pedal, compressing the spring. When a drummer moves his foot away from the foot pedal, the spring bias opens the hi-hat.

The distance between cymbals may be varied by adjustment of the clamping device on the rod supporting the upper cymbal according to the preference of the drummer. But in the practice of the art, the drummer finds it necessary to spend some time making this adjustment because for each drummer the distance needs to be set precisely to optimize the speed, feel, and sound response that each drummer seeks for his performance. In many cases the drummer may wish to make fine adjustments to this distance during the course of a performance, where the sound he is seeking changes between louder and softer, or his action changes between quicker and smoother. Because of the compression of the felts pads supporting the cymbals and the tolerances inherent in the clamping device set screws, the adjustment device of the prior art does not lend itself to either quick or precise adjustment.

Numerous devices concerning the mechanisms of hi-hat actuation have been disclosed in the prior art. Thus, in U.S. Pat. No. 6,049,032 Liao discloses a swinging stand transmission device for actuating the hi-hat. This rather complicated apparatus comprises numerous parts, including adjustment features with small and inaccessible set screws such as allen screws that act upon the support rod for the upper cymbal. These adjustment devices are not generally readily accessible during the course of a performance, and it is necessary to incorporate into the hi-hat the usual upper cymbal adjustment devices.

In U.S. Pat. No. 6,878,868 McMillan discloses a portable high-hat device where non-standard smaller cymbals are mounted to the side of a snare drum for use by a drummer in a marching band or drum line. The cymbals are actuated by the drummer's arm through a cable and lever assembly. Adjustment of the open distance between cymbals is accomplished with respect to the upper cymbal by the usual means of a thumb screw through the mounting collar on the support rod.

In U.S. Pat. No. 6,245,980 May discloses a system of support rods and clamps intended for use in display and marketing of multiple cymbals, but which may also be used typically in orchestral performances. The clamps and rod system is not part of a hi-hat device, and no advantage is obtained by use of them in the usual hi-hat assemblies.

In U.S. Pat. No. 6,977,333 Sutej discloses a system of operating multiple hi-hats through a single foot pedal, where the master hi-hat is operated directly by the foot pedal through usual linkages, and a plurality of slave hi-hats are simultaneously operated through the same foot pedal by sheathed flexible cables. Each of the master and the plurality of slave hi-hats are adjusted by the traditional methods from the prior art as described above.

In U.S. Pat. No. 7,123,050 Lombardi discloses a hook and lever device where the upper cymbal may be dropped during performance upon the lower cymbal by manual action upon the lever at the upper cymbal, which disengages the hook that suspends the cymbal. A foot pedal resets the upper cymbal through sheathed flexible cables.

In U.S. Pat. No. 7,115,805 Vandervoot discloses a rather complicated foot pedal that permits the playing of multiple drums, hi-hats and other instruments without repositioning the drummer's foot.

Thus the prior art is replete with devices and methods to improve the ability of the drummer to perform using hi-hat cymbal assemblies. What is needed, but has not been addressed in the prior art, is the means and a method of quickly and precisely adjusting the distance between the upper and lower cymbals of the hi-hat so that the performer may better control the speed, sound, and feel of the hi-hat during his performance.

### SUMMARY OF THE INVENTION

The present invention addresses the foregoing needs by incorporating a fine adjustment capability in the lower cymbal support, so that the lower cymbal, which is not usually adjusted, can be quickly and precisely adjusted vertically to set the distance between cymbals to meet the needs and desires of the drummer during his performance.

The adjustability of the lower cymbal is achieved in the present invention by modifying the support shaft of the hi-hat stand, where an outer sleeve has a length of screw threads machined into its interior surface at one end. This is used in conjunction with an inner sleeve of suitably smaller diameter, where screw threads of the same pitch are machined into the outer surface for some length at the lower end. When assembled, the inner sleeve is screwed into the outer sleeve partially, with the support rod for the upper cymbal passing through both in the usual manner. The upper end of the inner sleeve has the usual mounting hardware and felt pads from the prior art. Thus, fine adjustment of the height of the lower cymbal can be quickly achieved by twisting the inner sleeve clockwise or counterclockwise to meet the needs of the drummer.

Additionally, to prevent the movement of the adjusted inner and outer sleeves with respect to each other due to vibration during a performance, a locking ring is incorporated in the present invention. This locking ring consists of a nut or a short length of sleeve similar in diameter to the threaded outer sleeve, and with the same screw threads machined on the inside. By placing the locking ring on the inner sleeve threads, and then screwing the inner sleeve into the outer sleeve so that the lower cymbal is at the desired height, the locking ring may be twisted down against the outer sleeve to finger-tight tension, and reversibly jam and secure the positions of the inner and outer sleeves with respect to each other.

The present invention may be incorporated into existing hi-hat apparatus, including those with traditional set screw or thumb-screw adjustments of the upper cymbal position, as well as set-screw adjustment of the lower support shaft. Both of these adjustments from the prior art will continue to serve to set the overall height of the upper and lower cymbals respectively, as well as to set the rough adjustment for the distance between the cymbals. The inclusion of the present invention gives the drummer the capability to make fine, precise adjustment of the distance between cymbals rapidly and easily.

### OBJECTS OF THE INVENTION

It is an object of the present invention to provide the means for a drummer to precisely adjust the distance between cymbals in a hi-hat assembly to optimize the speed, sound and feel of the hi-hat during a performance.

It is also an object of the present invention to provide the means for a drummer to quickly make precise adjustments of the distance between cymbals in a hi-hat assembly, so that such adjustments may be made during a performance.

Other objects, features and advantages of the present invention will become apparent from the following description when taken in conjunction with the accompanying drawings wherein like characters of reference designate corresponding parts throughout the several views.

### BRIEF DESCRIPTION OF THE DRAWINGS

FIG. 1 shows a cross section view of the present invention.

FIG. 2 shows a close-up disassembled cross section view of the present invention.

FIG. 3 shows a close up assembled cross section view of the present invention.

FIG. 4 shows a cross section view of the present invention with coarse adjustment capability.

### DETAILED DESCRIPTION OF EXEMPLARY EMBODIMENTS

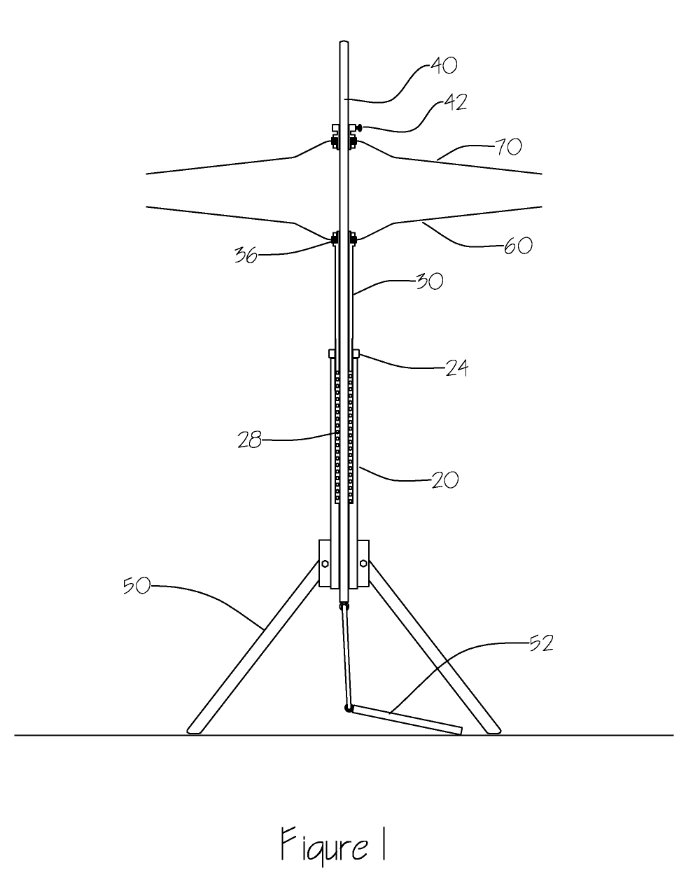

The present invention incorporates a fine adjustment capability in the lower cymbal support shaft 20, as shown in FIG. 1, so that the lower cymbal 60, which is not usually adjusted, may be quickly and precisely adjusted vertically to set the distance between cymbals to meet the needs and desires of the drummer during his performance.

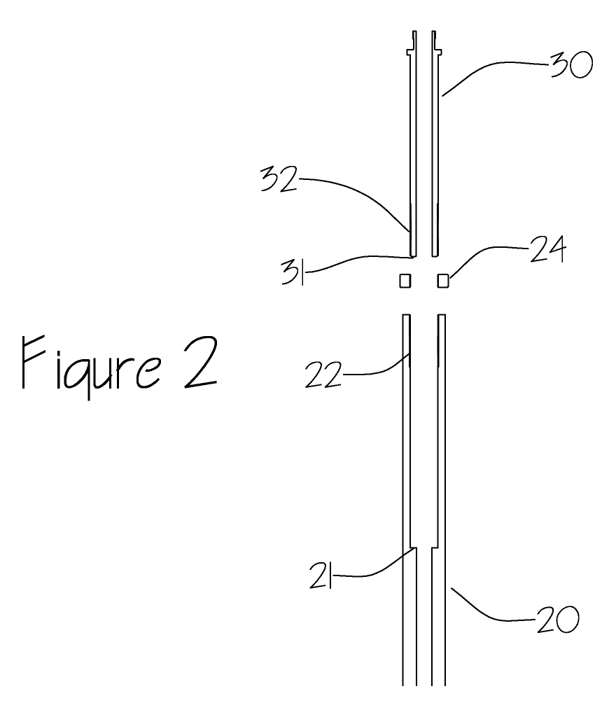

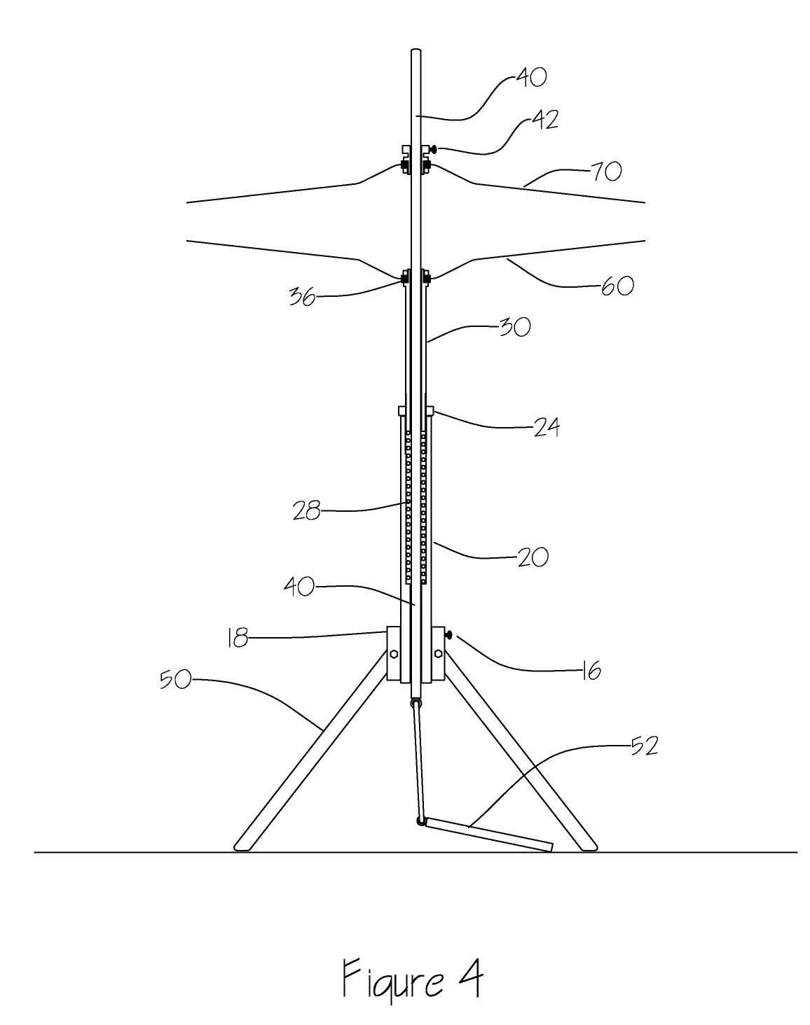

The adjustability of the lower cymbal 60 is achieved in the present invention where the support shaft of the hi-hat stand comprises an outer sleeve 20 with a length of screw threads 22 machined into its interior surface at the upper end, as shown in FIG. 2. The length of the threads may be any suitable distance, but preferably vary between about 2 inches and 6 inches. The lower end of the outer sleeve may attach directly to the base 50, where it receives the foot pedal mechanism 52. Alternately it may incorporate means for a coarse overall height adjustment as used in the prior art, such as a base sleeve 10 fixed concentrically about the outer sleeve 20 with set-screw 16 in a collar 18, as shown in FIG. 4.

This outer sleeve 20 is used in conjunction with an inner sleeve 30 of suitable diameter, where screw threads 32 of the same pitch are machined into the outer surface at the lower end. Although the entire length of the inner sleeve 30 may be threaded, this is not strictly necessary and may not be the preferred choice for some drummers for aesthetic reasons. The threaded length 32 of the inner sleeve 30 may be any suitable length but preferably varies between about three and eight inches.

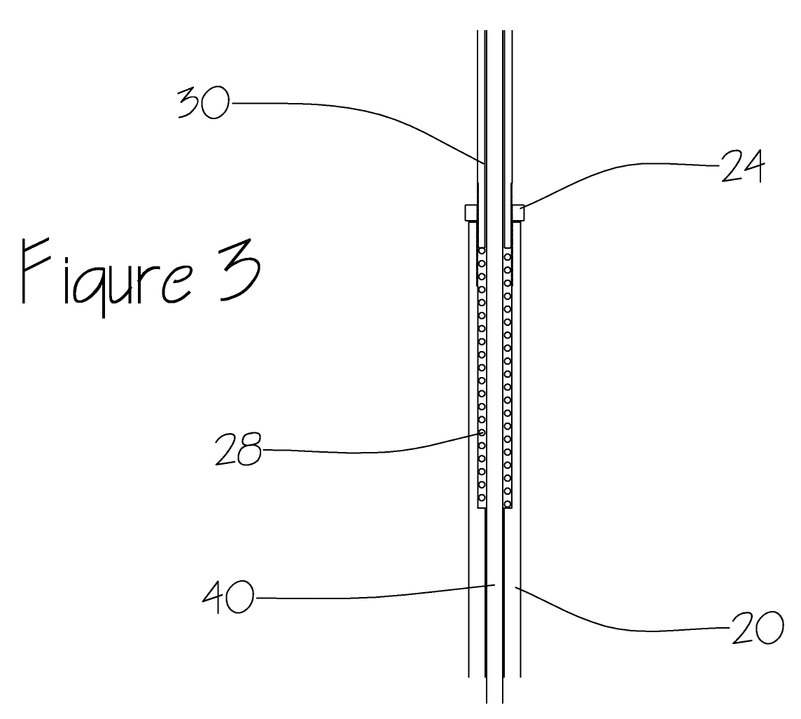

When assembled, as shown in FIG. 3, the inner sleeve 30 is screwed into the outer sleeve 20 partially, with the support rod 40 for the upper cymbal 70 passing through both in the usual manner. The upper end of the inner sleeve 30 has the usual mounting flange 34 and felt pads 36 from the prior art to support the lower cymbal 60. Thus, fine adjustment of the height of the lower cymbal 60 may be quickly and easily achieved by twisting the inner sleeve 30 clockwise or counterclockwise to meet the purpose of the drummer.

Additionally, to prevent the movement of the adjusted inner sleeve 30 and outer sleeve 20 with respect to each other due to vibration during a performance, a locking ring 24 is incorporated in the present invention. This locking ring consists of a machine nut or a short length of suitable diameter sleeve similar to the diameter of the threaded outer sleeve 20, and with the same pitch screw threads machined on the inside. By placing the locking ring 24 on the inner sleeve threads 32, and then screwing the inner sleeve 30 into the outer sleeve 20 so that the lower cymbal 60 is at the desired height, the locking ring 24 may be twisted down against the outer sleeve to finger-tight tension, and reversibly jam and secure the positions of the inner sleeve and outer sleeve with respect to each other.

To assist in adjusting and securing the components of the present invention, a coil spring 28 of suitable dimensions and spring force may be incorporated within the outer sleeve 20, so that it exerts a constant pressure against the bottom end 31 of the inner shaft 30. The lower end of the spring 28 may rest against a shoulder 21 machined into the outer shaft 20, as shown in FIGS. 2 and 3. Alternatively the lower end of the spring 28 may be retained by a collar at the bottom end of the outer sleeve 20, or by similar means readily apparent to those skilled in the art.

The present invention may be incorporated into an existing hi-hat apparatus, as shown in FIG. 4. This includes those with traditional set-screw 42 or thumb-screw adjustments of the upper cymbal 70 position, as well as set-screw 16 adjustment at the lower support shaft 10. Both of these adjustments from the prior art may be used to advantage to set the general overall height of the upper and lower cymbals respectively, as well as to set the rough adjustment for the distance between the cymbals. Other devices from the prior art may be incorporated as well, such as different designs for the tripod base 50, or foot pedal 52.

By the incorporation of the present invention into hi-hat assemblies, the drummer gains the capability to make fine, precise adjustment of the distance between cymbals rapidly and easily, including during a performance.

Although the foregoing embodiments of the present invention have been described in some detail by way of illustration and example for purposes of clarity and understanding, it will be apparent to those skilled in the art that certain changes and modifications may be practiced within the spirit and scope of the present invention. Therefore, the description and examples presented herein should not be construed to limit the scope of the present invention, the essential features of which are set forth in the appended claims.

I claim:

1. A lower cymbal vertical support fine adjustment device for hi-hat cymbal sets comprising
a) an inner sleeve with male screw threads, and
b) an outer sleeve with female screw threads;
where the said inner sleeve is variably partially screwed into the said outer sleeve to provide means for adjustment of the length of the said lower cymbal vertical support.

2. A lower cymbal vertical support fine adjustment device for hi-hat cymbal sets comprising
a) an inner sleeve with male screw threads, and
b) an outer sleeve with female screw threads, and
c) a locking ring with female threads;
where the said locking ring is screwed onto the male threads of the said inner sleeve, the said inner sleeve is then variably partially screwed into the said outer sleeve thereby providing means for adjustment of the length of the said lower cymbal vertical support, and the said locking ring is screwed to rest securely against the end surface of the said outer sleeve.

3. A lower cymbal vertical support fine adjustment device for hi-hat cymbal sets comprising
a) an inner sleeve with male screw threads, and
b) an outer sleeve with female screw threads, and
c) a locking ring with female threads, and
d) a coil spring;
where the said coil spring is contained inside the said outer sleeve and applies tension between the said inner sleeve and the said outer sleeve, the said locking ring is screwed onto the male threads of the said inner sleeve, the said inner sleeve is then variably partially screwed into the said outer sleeve thereby providing means for adjustment of the length of the said lower cymbal vertical support, and the said locking ring is screwed to rest securely against the end surface of the said outer sleeve.
